(19) United States
(12) Patent Application Publication
(10) Pub. No.: US 2011/0175263 A1
(43) Pub. Date: Jul. 21, 2011

(54) GLASS ENCAPSULATED HOT ISOSTATIC PRESSED SILICON CARBIDE

(76) Inventors: Vimal K. Pujari, Northborough, MA (US); James T. Hennessey, Rutland, MA (US)

(21) Appl. No.: 12/841,436

(22) Filed: Jul. 22, 2010

Related U.S. Application Data
(60) Provisional application No. 61/271,735, filed on Jul. 24, 2009.

(51) Int. Cl. C04B 35/64

(52) U.S. Cl. 264/604

(57) ABSTRACT

A method of forming a silicon carbide sintered body includes mixing silicon carbide powder with a boron additive and carbon to form a green mixture and shaping the green mixture into a green body, and coating the green body with boron nitride. The method further includes glass encapsulating the green body and hot isostatic pressing the glass encapsulated green body at a temperature in a range of between about 1900° C. and about 2400° C. for a time period in a range of between about one hour and about three hours, to thereby form a silicon carbide sintered body having a density at least 97% of the theoretical density of silicon carbide.

### RELATED APPLICATION

This application claims the benefit of U.S. Provisional Application No. 61/271,735, filed on Jul. 24, 2009.

The entire teachings of the above application are incorporated herein by reference.

### BACKGROUND OF THE INVENTION

The chemical and physical properties of silicon carbide make it an excellent material for high temperature structural components. These properties include good oxidation and corrosion resistance, a good heat transfer coefficient, a low coefficient of thermal expansion, high thermal shock and wear resistance, high strength at elevated temperatures, and high hardness and fracture resistance. It is in particular desirable to produce silicon carbide bodies having high density and suitable for engineering material uses. For such applications, silicon carbide, which is produced in the form of particles or powder form, must be formed into dense bodies, with a density close to the theoretical density (TD). Silicon carbide components generally have been made using either hot pressing techniques (i.e., sintering under high pressure) or pressureless sintering (i.e., sintering without applying pressure).

Typically, hot pressing processes are limited to relatively small and geometrically simple articles. Also, hot pressing processes generally are energy intensive and require additional molding materials.

Attempts have been made to replace hot pressing by pressureless sintering, to manufacture articles from a composite material including silicon carbide. Pressureless sintering is advantageous compared to hot pressing with respect to process costs and ability of processing in a continuous mode and/or a scale-up to commercial production. Generally, it has been a challenge for conventional pressureless-sintering processes to obtain sintering densities at lower temperatures (lower than about 2000° C.) of more than about 95% TD.

Silicon carbide can form in two phases, the beta (β) phase, and the thermodynamically more stable alpha (α) phase that forms at temperatures of about 2000° C. and higher. The onset of exaggerated growth of large tabular α-silicon carbide (α-SiC) crystals on densification of β-silicon carbide (β-SiC) powders is a limitation to obtaining the uniform fine-grained (average diameter of less than about 5 μm) microstructures necessary to withstand fracture, especially at temperatures of the order of about 1900° C. and higher. Therefore, a method of obtaining fine-grained α-silicon carbide is needed, in order to produce high hardness and fracture resistant silicon carbide components.

Another potential application for silicon carbide structural components is for nuclear reactor fuel rods. The rods are constructed as cylinders that contain the nuclear fuel. The cylinders are typically made of zircaloy (a high zirconium metal alloy), due to its low absorption cross section of thermal neutrons. Cylinders made of silicon carbide would have a number of advantages over zircaloy, such as, for example, longer useful life, higher corrosion resistance, a lower absorption cross section for thermal neutrons, and greater stiffness. This application, however, requires the use of β-silicon carbide, because α-silicon carbide exhibits unacceptable swelling under neutron bombardment. Therefore, a method of sintering β-silicon carbide is needed that does not lead to the transformation of β-silicon carbide into α-silicon carbide in a silicon carbide component.

Another possible cause for the swelling of silicon carbide fuel rods under neutron bombardment is the ¹⁰B isotope in the boron sintering aid (20% natural abundance), typically added in the form of boron carbide or boron powder. Therefore, there is a need for a method of sintering silicon carbide using ¹¹B as a sintering aid.

### SUMMARY OF THE INVENTION

The present invention generally relates to a method of forming a silicon carbide sintered body by shaping a green mixture of α-silicon carbide, β-silicon carbide, or a combination thereof into a green body, glass encapsulating the green body, and hot isostatic pressing the glass encapsulated green body to thereby form a silicon carbide sintered body having a density at least 97% of the theoretical density of silicon carbide.

In some embodiments, a method of forming a silicon carbide sintered body includes mixing silicon carbide powder with a boron additive and carbon to form a green mixture and shaping the green mixture into a green body, and coating the green body with boron nitride. The method further includes glass encapsulating the green body and hot isostatic pressing the glass encapsulated green body at a temperature in a range of between about 1900° C. and about 2400° C. for a time period in a range of between about one hour and about three hours, to thereby form a silicon carbide sintered body having a density at least 97% of the theoretical density of silicon carbide. The silicon carbide powder can have a surface area equal to or less than about 22 m²/g. The step of hot isostatic pressing can be conducted at a pressure in a range of between about 10,000 lb/in² and about 30,000 lb/in². In some embodiments, the step of hot isostatic pressing can be conducted at a pressure in a range of between about 15,000 lb/in² and about 30,000 lb/in². The carbon can be present at least in part as a phenolic resin in the green mixture, in an amount in a range of about 1 wt % and about 5 wt %. In some embodiments, the silicon carbide power can include β-silicon carbide having a surface area in a range of between about 10 m²/g and about 22 m²/g. In certain embodiments, the silicon carbide powder can consist essentially of β-silicon carbide having a surface area in a range of between about 10 m²/g and about 22 m²/g. The boron additive can be present at least in part as boron carbide in the green mixture, in an amount in a range of between 0.15 wt % and about 0.5 wt % boron carbide. In some embodiments, the boron additive can be present at least in part as boron powder in the green mixture in an amount in a range of between about 0.1 wt % and about 0.5 wt %, wherein the boron powder consists essentially of ¹¹B isotope of boron. The step of hot isostatic pressing can be conducted at a temperature in a range of between about 1800° C. and about 2150° C., and the silicon carbide sintered body can be composed of least about 70 wt β-silicon carbide.

In certain embodiments, the silicon carbide powder can include α-silicon carbide having a surface area in a range of between about 8 m²/g and about 18 m²/g. In other embodiments, the silicon carbide powder can consist essentially of α-silicon carbide having a surface area in the range of between about 8 m²/g and about 18 m²/g. In some embodiments, the boron additive is present at least in part as boron carbide in the green mixture in an amount in the range of between about 0.1 wt % and about 0.5 wt % boron carbide. In some embodiments, the step of hot isostatic pressing is conducted at a temperature in a range of between about 1800° C. and about 2150° C., and the silicon carbide body can include more than 95% wt % α-silicon carbide particles having an average diameter of less than about 5 μm. In certain embodiments, the silicon carbide powder can include α-silicon carbide as a major component, and β-silicon carbide is a minor component. In still other embodiments, the silicon carbide powder can consist essentially of α-silicon carbide as a major component, and β-silicon carbide as a minor component. In some embodiments, the step of hot isostatic pressing can be performed at a temperature in a range of about 1950° C. to about 2200° C., and the silicon carbide centered body can include elongated particles of α-silicon carbide and α-silicon carbide particles having an average diameter of less than about 5 μm.

In another embodiment, a method of producing a silicon carbide sintered body includes mixing silicon carbide powder with a boron additive and a sintering aid to form a green mixture, shaping the green mixture into a green body, and coating the green body with boron nitride. The method further includes glass encapsulating the green body and hot isostatic pressing the glass encapsulated green body at a temperature in a range of between about 1600° C. and about 2150° C. for a time period in a range of between about one hour and about three hours to thereby form a silicon carbide sintered body having a density at least 97% of the theoretical density of silicon carbide. The sintering aid can include a rare earth oxide, alumina, magnesium oxide, titanium dioxide, or any combination thereof. In some embodiments, the sintering aid can consists essentially of a rare earth oxide, alumina, magnesium oxide, titanium dioxide, or any combination thereof.

In certain embodiments, the silicon carbide powder can include α-silicon carbide powder as a major component, and β-silicon carbide powder as a minor component. In certain other embodiments, the silicon carbide powder can consist essentially of α-silicon carbide powder, and βsilicon carbide powder as a minor component. In some embodiments, the step of hot isostatic pressing can be conducted at a temperature in a range of between about 1800° C. and about 2150° C., and the silicon carbide sintered body can include elongated particles of α-SiC and α-SiC particles having an average diameter of less than about 5 μm.

This invention has many advantages, including, for example, enabling the development of fine grain silicon carbide microstructures with improved hardness, elastic modulus and wear resistance, and the development of nuclear reactor fuel rods with longer useful life, higher corrosion resistance, lower absorption cross section for thermal neutrons, and greater stiffness.

### DETAILED DESCRIPTION OF THE INVENTION

A method of forming a silicon carbide sintered body includes mixing silicon carbide powder with a boron additive and carbon to form a green mixture and shaping the green mixture into a green body, and coating the green body with boron nitride. A high surface area (>18 m²/g, preferably about 22 m²/g, with an average diameter (d₅₀) of about 0.3 μm) β-silicon carbide powder (Superior Graphite, Chicago, Ill.) was mixed with boron carbide in an amount in a range of between about 0.15 wt % and about 0.5 wt %, preferably about 0.4 wt % boron carbide, or with ¹¹B boron powder (99 atom % ¹¹B) in an amount in a range of between about 0.15 wt % and about 0.5 wt %, preferably about 0.4 wt % ¹¹B boron powder, and carbon in an amount in a range of between about 1 wt % and about 5 wt %, preferably about 3 wt %, in an aqueous solution at pH of about 9. Boron powder containing the ¹¹B isotope (99 atom %) can be obtained commercially, for example, from American Elements (Los Angeles, Calif.). Any suitable carbon precursors, such as carbon-containing organic compounds (e.g., phenolic resins), and elemental carbon (carbon black or graphite), or combinations thereof, can be used. A preferred carbon precursor is phenolic resin. After high shear mixing, the slurry was freeze dried and screened using a 140 mesh screen.

A desired shape, such as a desired three-dimensional shape, of silicon carbide can be formed by pressing the dried mixture of boron carbide powder, sintering aid, and pressing aid into a green body. The shaping can be carried out according to any suitable known method, for example, by die-pressing, cold isostatic pressing, injection molding, extruding or slip casting. In the case of die-pressing in molds or isostatic pressing, a pressure of from 15 to 30 KSI (15,000 to 30,000 lb/in²), preferably about 24 KSI, is generally used. Any desired three-dimensional shape can be formed, such as, for example, disks. The disks were heated to a temperature of about 650° C. in a nitrogen atmosphere to remove volatile organic binders. The binder-free disks were dip coated in boron nitride to a coating thickness in a range of between about 0.1 and about 0.5 μm, using a non-aqueous (isopropyl alcohol) boron nitride suspension. The dip coated disks were then air dried.

The method further includes glass encapsulating the green body and hot isostatic pressing (HIP) the glass encapsulated green body at a temperature in a range of between about 1800° C. and about 2400° C., preferably about 1900° C., for a time period in a range of between about one hour and about three hours, preferably about one hour, to thereby form a silicon carbide sintered body having a density at least 97% of the theoretical density of silicon carbide. The method of glass encapsulating the green body is described in U.S. Pat. Nos. 5,284,616, 5,080,843, 4,883,639, and 4,778,650. The step of hot isostatic pressing can be conducted at a pressure in a range of between about 10 KSI and about 30 KSI. In some embodiments, the step of hot isostatic pressing can be conducted at a pressure in a range of between about 15 KSI and about 30 KSI. The step of hot isostatic pressing can be conducted at a temperature in a range of between about 1800° C. and about 2150° C., preferably at about 1900° C. The density of the silicon carbide sintered body was measured at 97.2% of the theoretical density of silicon carbide. XRD analysis showed that the microstructure of the silicon carbide sintered body retained about 73.2% β-silicon carbide, about 3.8% α-silicon carbide, and about 3% carbon/graphite.

The silicon carbide powder can include α-silicon carbide having a surface area in a range of between about 8 m²/g and about 18 m²/g. After the processing steps described above, fine-grained (average particle diameter of less than about 5 μm) α-silicon carbide with a density higher than about 97.5% of the theoretical density of silicon carbide can be produced.

Alternatively, the silicon carbide powder can include α-silicon carbide powder as a major component, preferably about 80 wt %, and β-silicon carbide powder as a minor component, preferably about 80 wt %, based on the combined weight of silicon carbide powder. In this embodiment, the step of hot isostatic pressing can be conducted at a temperature in a range of between about 1800° C. and about 2150° C., and the silicon carbide sintered body can include elongated particles of α-SiC among α-SiC particles having an average diameter of less than about 5 μm.

In another alternative embodiment, the method of producing a silicon carbide sintered body can include using a sintering aid comprising rare earth oxides, alumina, magnesium oxide, titanium dioxide, or any combination thereof, but no carbon. The silicon carbide powder can be α-silicon carbide or β-silicon carbide, or a combination thereof. The green mixture can be sintered at a temperature in a range of between about 1600° C. and about 1980° C. to thereby achieve sintered densities equal to or greater than 97% TD with elongated microstructures that are expected to impart high toughness to the sintered silicon carbide bodies.

### EXEMPLIFICATION

A summary of properties of sintered silicon carbide bodies formed by the methods described above is shown in Table 1, in the bottom two rows, and compared to sintered silicon carbide bodies formed by standard methods.

TABLE 1
Sintered SiC properties and phase composition (6H = α, 4H = α, 3C = β)

| | | | | | fracture | | |
|---|---|---|---|---|---|---|---|
| SiC | | Sintered | | | toughness - | | |
| Powder | | density | | Hardness | KIC | Sintered | |
| phase | Boron | (% TD) | Phases | (GPa) | (MPa-m^{1/2}) | Phase Notes | Conditions |
| Alpha | B4C | 98 | 6H, | 25 | 2.5 | α | 2150C/Ar |
| (SA) | | | 4H-100% | | | | pressureless |
| Alpha | B11 | 98 | 6H, | 25.2 | 2.5 | α | 2150C/Ar |
| (SA) | | | 4H-100% | | | | pressureless |
| | | | | | | | Properties |
| | | | | | | | identical to SA |
| | | | | | | | with B4C |
| Beta | B4C | 94.3 | 3C-6% | 19.8 | 3.2 | β-> α | Sintered at |
| | B11 | 94.2 | 3C-11.2% | 20.4 | 3.5 | | 2010C/Ar |
| | | | | | | | pressureless |
| Beta | B4C & | 67 | — | — | — | insufficient | Sintered at |
| | B11 | | | | | densification | 1950C/N2/2 Hr |
| | | | | | | | pressureless |
| Beta | B4C | >97 | 3C-75% | 16 | 4.18 | β | Direct Glass |
| | (B10) | | 6H-21% | | | | HIP |
| | | | C-4% | | | | 1900C/1 Hr/Ar |
| Beta | B4C, B11 | >97 | 3C-75% | 17.1 | 3.56 | β | Direct Glass |
| | | | 6H-21% | | | | HIP |
| | | | C-4% | | | | 1900C/1 Hr/Ar |

Samples of sintered silicon carbide bodies formed by the methods described above and control samples of materials formed by standard methods were subjected to high-flux neutron irradiation in a water-moderated mixed-spectrum 85 MW nuclear reactor (HFIR, Oak Ridge National Laboratory). The irradiation temperature was 320±20° C. and the neutron fluence was 5.8×10²¹ n/m² (E>0.1 MeV). Swelling of the samples was measured from the change in length of the 25 mm×1 mm×1 mm samples. The test results are shown in Table 2.

TABLE 2
Summary of post-irradiation test results

| | Swelling (dL/L) ± | |
|---|---|---|
| Material | standard deviation, % | Comment |
| SA-B10 Hexoloy | 2.14 ± 0.23 | |
| SA-B11 Hexoloy | 2.01 ± 0.28 | |
| Beta B10 B4C | 2.24 ± 0.23 | Direct Glass HIP |
| | | 1900 C./1 Hr/Ar |
| Beta B11 B4C | 1.88 ± 0.30 | Direct Glass HIP |
| | | 1900 C./1 Hr/Ar |
| TREX CVD SiC | 1.85 ± 0.29 | |

The results shown in Table 2 indicate that the beta silicon carbide material prepared according to the methods of this invention (direct glass HIP) and including boron carbide containing the ¹¹B isotope of boron showed lower swelling than the corresponding ¹⁰B isotope material. The swelling results for the ¹¹B material matched the chemical vapor deposited (CVD) SiC from TREX (San Diego, Calif.).

The teachings of all patents, published applications and references cited herein are incorporated by reference in their entirety.

### EQUIVALENTS

While this invention has been particularly shown and described with references to example embodiments thereof, it will be understood by those skilled in the art that various changes in form and details may be made therein without departing from the scope of the invention encompassed by the appended claims.

What is claimed is:

1. A method of forming a silicon carbide sintered body comprising:
mixing silicon carbide powder with a boron additive and carbon to form a green mixture;
shaping the green mixture into a green body;
coating the green body with boron nitride;
glass encapsulating the green body; and
hot isostatic pressing the glass encapsulated green body at a temperature in a range of between about 1900° C. and about 2400° C. for a time period in a range of between about one hour and about three hours, to thereby form a silicon carbide sintered body having a density at least 97% of the theoretical density of silicon carbide.

2. The method of claim 1, wherein the silicon carbide powder has a surface area equal to or less than about 22 m²/g.

3. The method of claim 1, wherein the step of hot isostatic pressing is conducted at a pressure in a range of between about 10,000 lb/in² and about 30,000 lb/in².

4. The method of claim 3, wherein the step of hot isostatic pressing is conducted at a pressure in a range of between about 15,000 lb/in² and about 30,000 lb/in².

5. The method of claim 3, wherein the carbon is present at least in part as a phenolic resin in the green mixture in an amount in a range of about 1 wt % and about 5 wt %.

6. The method of claim 5, wherein the silicon carbide powder includes β-SiC having a surface area in a range of between about 10 m²/g and about 22 m²/g.

7. The method of claim 6, wherein the silicon carbide powder consists essentially of β-SiC having a surface area in a range of between about 10 m²/g and about 22 m²/g.

8. The method of claim 6, wherein the boron additive is present at least in part as boron carbide in the green mixture in an amount in a range of between about 0.15 wt % and about 0.5 wt % boron carbide.

9. The method of claim 6, wherein the boron additive is present at least in part as boron powder in the green mixture in an amount in a range of between about 0.1 wt % and about 0.5 wt %, and wherein the boron powder consists essentially of ¹¹B isotope of boron.

10. The method of claim 6, wherein the step of hot isostatic pressing is conducted at a temperature in a range of between about 1800° C. and about 2150° C., and the silicon carbide sintered body is composed of at least about 70 wt % β-SiC.

11. The method of claim 5, wherein the silicon carbide powder includes α-SiC having a surface area in a range of between about 8 m²/g and about 18 m²/g.

12. The method of claim 11, wherein the silicon carbide powder consists essentially of α-SiC having a surface area in a range of between about 8 m²/g and about 18 m²/g.

13. The method of claim 11, wherein the boron additive is present at least in part as boron carbide in the green mixture in an amount in a range of between about 0.1 wt % and about 0.5 wt % boron carbide.

14. The method of claim 11, wherein the boron additive is present at least in part as boron powder in the green mixture in an amount in a range of between about 0.1 wt % and about 0.5 wt %, and wherein the boron powder consists essentially of ¹¹B isotope of boron.

15. The method of claim 11, wherein the step of hot isostatic pressing is conducted at a temperature in a range of between about 1800° C. and about 2150° C., and the silicon carbide sintered body includes more than 95 wt % α-SiC particles having an average diameter of less than about 5 μm.

16. The method of claim 5, wherein the silicon carbide powder includes α-SiC as a major component and β-SiC as a minor component.

17. The method of claim 5, wherein the silicon carbide powder consists essentially of α-SiC as a major component and β-SiC as a minor component.

18. The method of claim 16, wherein the step of hot isostatic pressing is performed at a temperature in a range of about 1950° C. to about 2200° C., and the silicon carbide sintered body includes elongated particles of α-SiC and α-SiC particles having an average diameter of less than about 5 μm.

19. A method of producing a silicon carbide sintered body comprising:
mixing silicon carbide powder with a boron additive and a sintering aid to form a green mixture;
shaping the green mixture into a green body;
coating the green body with boron nitride;
glass encapsulating the green body; and
hot isostatic pressing the glass encapsulated green body at a pressure in a range of between 10 lb/in² and about 30 lb/in² and at a temperature in a range of between about 1600° C. and about 2150° C. for a time period in a range of between about one hour and about three hours, to thereby form a silicon carbide sintered body having a density at least 97% of the theoretical density of silicon carbide.

20. The method of claim 19, wherein the sintering aid includes a rare earth oxide, alumina, magnesium oxide, titanium dioxide, or any combination thereof.

21. The method of claim 19, wherein the sintering aid consists essentially of a rare earth oxide, alumina, magnesium oxide, titanium dioxide, or any combination thereof.
